(19) United States
(12) Patent Application Publication
(10) Pub. No.: US 2015/0032480 A1
(43) Pub. Date: Jan. 29, 2015

(54) USE OF E-RECEIPTS TO DETERMINE INSURANCE VALUATION

(71) Applicant: Bank of America Corporation, Charlotte, NC (US)

(72) Inventors: Jason P. Blackhurst, Charlotte, NC (US); Katherine Dintenfass, Charlotte, NC (US); Matthew A. Calman, Charlotte, NC (US); Laura C. Bondesen, Charlotte, NC (US); Carrie A. Hanson, Charlotte, NC (US)

(73) Assignee: Bank of America Corporation, Charlotte, NC (US)

(21) Appl. No.: 13/952,303

(22) Filed: Jul. 26, 2013

(51) Int. Cl. G06Q 40/08

(52) U.S. Cl. CPC G06Q 40/08
USPC 705/4

(57) ABSTRACT

Embodiments for determining insurance valuations are included in systems that receive e-receipt data, including stock keeping unit (SKU) level data from a customer and compare the e-receipt data with transaction data. The systems match the e-receipt data to one or more transactions based on the comparison, identify at least one insurance related transaction from the one or more transactions based on the SKU level data, calculate the value of an insurance claim based on the at least one insurance related transaction.

### BACKGROUND

Insurance policies are usually complex and detailed agreements that can be difficult for policy holders to navigate. Identifying and gathering the correct data to submit insurance claims, for example, is often challenging. Many consumers also have different types of insurance policies that each have their own unique set of terms and conditions, and in some cases the insurance policies may overlap for any given insured item. Due to the complex nature of insurance policies, some consumers may not be aware of the benefits, scope, and requirements of their insurance policies and may not appreciate how the products they purchase can impact insurance valuation.

### BRIEF SUMMARY

The embodiments provided herein are directed to systems for determining insurance valuations. In some embodiments, the systems include a computer apparatus including a processor and a memory and a valuation module stored in the memory, comprising executable instructions that when executed by the processor cause the processor to receive e-receipt data comprising stock keeping unit (SKU) level data from a customer. In some embodiments, the executable instructions further cause the processor to compare the e-receipt data with transaction data. In some embodiments, the executable instructions further cause the processor to match the e-receipt data to one or more transactions based on the comparison. In some embodiments, the executable instructions further cause the processor to identify at least one insurance related transaction from the one or more transactions based on the SKU level data. In some embodiments, the executable instructions further cause the processor to calculate the value of an insurance claim based on the at least one insurance related transaction.

In further embodiments of the systems, the executable instructions further cause the processor to receive insurance policy data from the customer; compare the insurance policy data and the at least one insurance related transaction calculate the purchase amount for the at least one insurance related transaction. In other embodiments, the executable instructions further cause the processor to adjust the purchase amount based on the insurance policy data, wherein the value of the insurance claim comprises the adjusted purchase amount. In still other embodiments, the executable instructions further cause the processor to determine an increase or decrease in payments associated with an insurance policy of the customer based on the insurance policy data and the at least one insurance related transaction comparison. In additional embodiments, the executable instructions further cause the processor to determine that the value of an insured item has increased or decreased based on the insurance policy data and the at least one insurance related transaction comparison. In some embodiments, the executable instructions further cause the processor to provide suggestions for modifying an existing insurance policy to the customer.

In other embodiments, the executable instructions further cause the processor to determine that the transaction data and the e-receipt data are dissimilar; and restructure the e-receipt data. In still other embodiments, the executable instructions further cause the processor to receive outside data, adjust the value of an insured item based on the outside data, wherein the outside data comprises data extracted from government records, statistical reports, valuation models, or consumer reviews. In further embodiments, the executable instructions further cause the processor to categorize the at least one insurance related transaction into one or more groups based on the SKU level data, customer input, or the transaction data. In still further embodiments, the executable instructions further cause the processor to receive insurance data comprising one or more insurance policies and match the one or more insurance policies to the one or more groups. In some embodiments, the executable instructions further cause the processor to receive a second value for the insurance claim, determine variances between the calculated value of the insurance claim and the second value of the insurance claim, and notify the customer of the variance.

Further provided herein are embodiments directed to a computer program product for determining insurance valuations. In some embodiments, the computer program product comprises a computer readable storage medium having computer readable program code embodied therewith, the computer readable program code comprising computer readable program code configured to receive e-receipt data comprising stock keeping unit (SKU) level data from a customer. In some embodiments, the computer program product further includes computer readable program code configured to compare the e-receipt data with transaction data. In some embodiments, the computer program product further includes computer readable program code configured to match the e-receipt data to one or more transactions based on the comparison. In some embodiments, the computer program product further includes computer readable program code configured to identify at least one insurance related transaction from the one or more transactions based on the SKU level data. In some embodiments, the computer program product further includes computer readable program code configured to calculate the value of an insurance claim based on the at least one insurance related transaction.

In additional embodiments, the computer program product further includes computer readable program code configured to receive insurance policy data from the customer and compare the insurance policy data and the at least one insurance related transaction calculate the purchase amount for the at least one insurance related transaction. In some embodiments, the computer program product further includes computer readable program code configured to adjust the purchase amount based on the insurance policy data, wherein the value of the insurance claim comprises the adjusted purchase amount. In other embodiments, the computer program product further includes computer readable program code configured to determine that the value of an insured item has increased or decreased based on the insurance policy data and the at least one insurance related transaction comparison. In still other embodiments, the computer program product further includes computer readable program code configured to determine that the transaction data and the e-receipt data are dissimilar and restructure the e-receipt data.

In additional embodiments, a computer-implemented method for determining insurance valuations is provided. In some embodiments, the method includes receiving e-receipt data comprising stock keeping unit (SKU) level data from a customer. In some embodiments, the method includes comparing, by a processor, the e-receipt data with transaction data. In some embodiments, the method includes matching, by a processor, the e-receipt data to one or more transactions based on the comparison. In some embodiments, the method includes identifying, by a processor, at least one insurance related transaction from the one or more transactions based on the SKU level data. In some embodiments, the method includes calculating, by a processor, the value of an insurance claim based on the at least one insurance related transaction.

In further embodiments of the method, the method includes receiving insurance policy data from the customer and comparing, by a processor, the insurance policy data and the at least one insurance related transaction calculate the purchase amount for the at least one insurance related transaction. In other embodiments, the method includes adjusting, by a processor, the purchase amount based on the insurance policy data, wherein the value of the insurance claim comprises the adjusted purchase amount. In some embodiments, the method includes determining, by a processor, an increase or decrease in payments associated with an insurance policy of the customer based on the insurance policy data and the at least one insurance related transaction comparison.

### BRIEF DESCRIPTION OF THE SEVERAL VIEWS OF THE DRAWINGS

The present embodiments are further described in the detailed description which follows in reference to the noted plurality of drawings by way of non-limiting examples of the present embodiments in which like reference numerals represent similar parts throughout the several views of the drawings and wherein:

FIG. 1 is a flowchart illustrating a process for determining insurance valuations in accordance with various embodiments;

FIG. 2 is a flowchart illustrating a process for determining insurance valuations in accordance with various embodiments;

FIG. 3 illustrates a system and environment for determining insurance valuations and analyzing e-receipt data accordance with various embodiments;

FIG. 4 illustrates the systems and/or devices in FIG. 2; and

FIG. 5 is an illustration of a graphical user interface for determining insurance valuations in accordance with various embodiments.

### DETAILED DESCRIPTION

The embodiments presented herein are directed to systems, methods, and computer program products for determining insurance valuations and evaluating e-receipt data and transaction data in light of insurance policies. The system retrieves and parses through e-receipt data along with transaction data to identify insurance related transactions. The identified transactions can be further analyzed and compared to the terms of one or more insurance policies. In this way, insurance claims can be valued, forms identified, records pushed to insurance companies, and insurance policy recommendations produced to enhance e-receipt and transaction data and enable customers to evaluate their purchases in light of their insurance policies.

The embodiments of the disclosure may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present embodiments of the disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present embodiments of the disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present embodiments of the disclosure are described below with reference to flowchart illustrations and/or block diagrams of methods, apparatus (systems) and computer program products according to embodiments of the embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

In the past few years, there has been an increase in the amount of electronic information provided by merchants to customers regarding purchase of products and services. In the online purchase context, various electronic communications may be provided to the customer from the merchant relative to a purchase. For example, following an online purchase, the merchant may provide the customer an electronic order confirmation communication. The order confirmation may be sent to the customer's computer and displayed in a web browser application. The web browser application typically allows the customer to print a hard copy of the order confirmation and to save the confirmation electronically. The merchant will also typically send an email containing the order confirmation to the customer's designated email account. The order confirmation is essentially an e-receipt for the online purchase. The order confirmation includes detailed information regarding the products or services purchased. For example, in the case of a product, the order confirmation may include stock keeping unit “SKU” code level data, which may include parameters such as order number, order date, product description, product name, product quantity, product price, and the like. Further, other parameters associated with the e-receipt can include product image, hyperlink to the product image on merchant website, sales tax, shipping cost, order total, billing address, shipping company, shipping address, estimated shipping date, estimated delivery date, tracking number, and the like. The order confirmation also includes information about the merchant, such as name, address, phone number, web address, and the like. For most online transactions, the merchant will send at least one second communication confirming shipment of the order. The order shipment confirmation is typically also sent via email to the customer and typically includes the same information as the order confirmation, and in addition, shipping date, tracking number, and other relevant information regarding the order and shipment parameters.

Many merchants now also provide e-receipts to customers shopping at brick and mortar locations. In general, at the point of sale, the customer may have previously configured or may be asked at the time of sale as to whether she wishes to receive an e-receipt. By selecting this option, the merchant will send an electronic communication in the form of an e-receipt to the customer's designated email address. Here again, the e-receipt will typically include a list of services and/or products purchased with SKU level data, and other parameters, as well as information about the merchant, such as name, address, phone number, store number, web address, and the like.

Various merchants now also provide online customer accounts for repeat customers. These online customer accounts may include purchase history information associated with the customer accessible by the customer via ID and passcode entry. Purchase history provides detailed information about services and products purchased by the customer including information found on order confirmations and shipping confirmations for each purchase. Online customer accounts are not limited to online purchases. Many merchants also provide online customer accounts for customers that purchase services and products at brick and mortar locations and then store these transactions in the customer's online account.

For the most part, order confirmations, shipping confirmations, e-receipts, and other electronic communications between merchants and customers are used only by the customer as proof of purchase and for monitoring receipt of purchased items (i.e., for archival purposes). However, there is significant data that can be gleaned from this electronic information for the benefit of the customer, so that the customer may have detailed information regarding purchase history, spending, and the like.

Another development in the past few years has been the growth of online banking, whereby financial institution customers, (such as bank and credit card customers), may view financial account transaction data, perform online payments and money transfers, view account balances, and the like. Many current online banking applications are fairly robust and provide customers with budgeting tools, financial calculators, and the like to assist the customer to not only perform and view financial transaction date, but also to manages finances. A current drawback with online banking is that transactional level detail for a given purchase by the customer is limited. Despite the large amount of information sent by merchants to customers regarding purchases, merchants currently do not provide purchase details to financial institutions. The only information provided to the financial institution is information about the merchant and an overall transaction amount. For example, if a financial institution customer purchases several clothing items from a merchant and uses a financial institution debit card, credit card or check, all that is provided to the financial institution is the merchant information and overall purchase. Product level detail that is present on the receipt provided to the customer by the merchant is not provided to the financial institution.

The lack of detailed information regarding a given transaction in the online banking environment limits a customer's ability to ascertain a larger picture of purchase history and financial transaction information. As a first example, if a customer makes several purchases within a short time period with a particular merchant, all that the customer will see in online banking for each purchase is an overall dollar amount, the merchant name, and date of the purchase transaction. If the customer cannot recall, what a particular purchase was for or whether it was a legitimate transaction, the customer cannot view details regarding the purchase via online banking to aid in the inquiry. Instead, the customer must locate and review receipts from the purchases and match them by date and/or total purchase amount to online banking data to perform such analysis.

Lack of detailed purchase information also hinders use of other financial tools available to the customer in online banking, such as budget tools. In general, budget tools divide expenses into various categories, such as food, clothing, housing, transportation, and the like. It is typically advantageous to provide such budget tools with online banking information to populate these various categories with spend information. However, this is difficult where specifics regarding a purchase made by the merchant (such as SKU level data) are not provided by the merchant to the financial institution for a given financial transaction. As many stores provide a wide variety of services and products, such as in the case of a “big box” store that provides groceries, clothing, house hold goods, automotive products, and even fuel, it is not possible to dissect a particular purchase transaction by a customer at the merchant for budget category purposes. For this reason, many current online budgeting tools may categorize purchases for budgeting by merchant type, such as gas station purchases are categorized under transportation and grocery store purchases are categorized under food, despite that in reality, the purchase at the gas station may have been for food or the purchase at the grocery store could have been for fuel. Alternatively, some budget tools may allow a customer to parse the total amount of a purchase transaction between budget categories by manually allocating amounts from the purchase transaction between each budget category. This requires added work by the customer and may be inaccurate, if the customer is not using the receipt in making such allocations.

Customer cash purchases are also problematic for integration of customer purchase transactions into online banking. In a cash transaction, the customer may initially withdraw cash from a financial account and then use the money for a purchase. In this instance, the customer's online banking will have no information whatsoever regarding the purchase transaction with a merchant, as there is no communication regarding the purchase transaction between the financial institution and the merchant. For example, if the customer uses cash to purchase fuel at a gas station, the financial institution has no way of determining that the purchase transaction occurred and cannot use such information for notifying customer of spending or budgeting regarding the fuel purchase.

As described above, currently financial institutions are not provided with detailed transaction level information regarding a purchase transaction by a customer from a merchant beyond merchant information and overall transaction price for inclusion in online banking. While detailed data (such as SKU level data) is provided to the customer via receipts, such information is not provided by the merchant to the financial institution. The information is available to the customer but not integratable into a customer's online banking for efficient and increased beneficial use of the information. Currently, a customer must retain her receipts and manually compare such receipts with online purchase transaction data to obtain an understanding of the details of a given purchase transaction.

In light of the above, the current invention contemplates use of e-receipt data and other electronic communication data between a merchant and customer regarding a transaction in order to augment purchase transaction data in online banking. The general concept is to retrieve such electronic communications from the customer, parse the data in these electronic communications, and associate the data from the electronic communications with the corresponding online purchase transaction data.

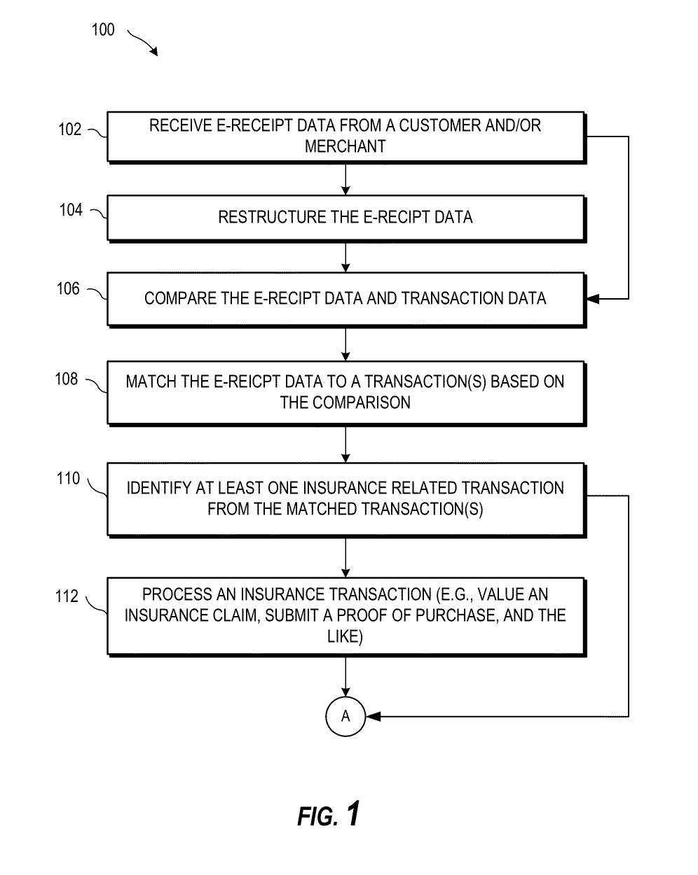

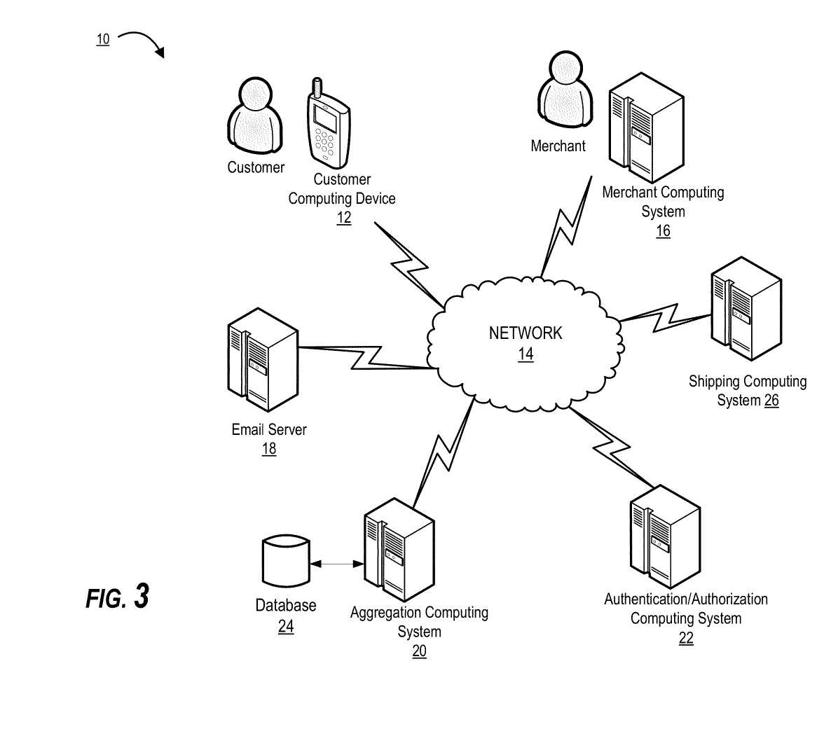

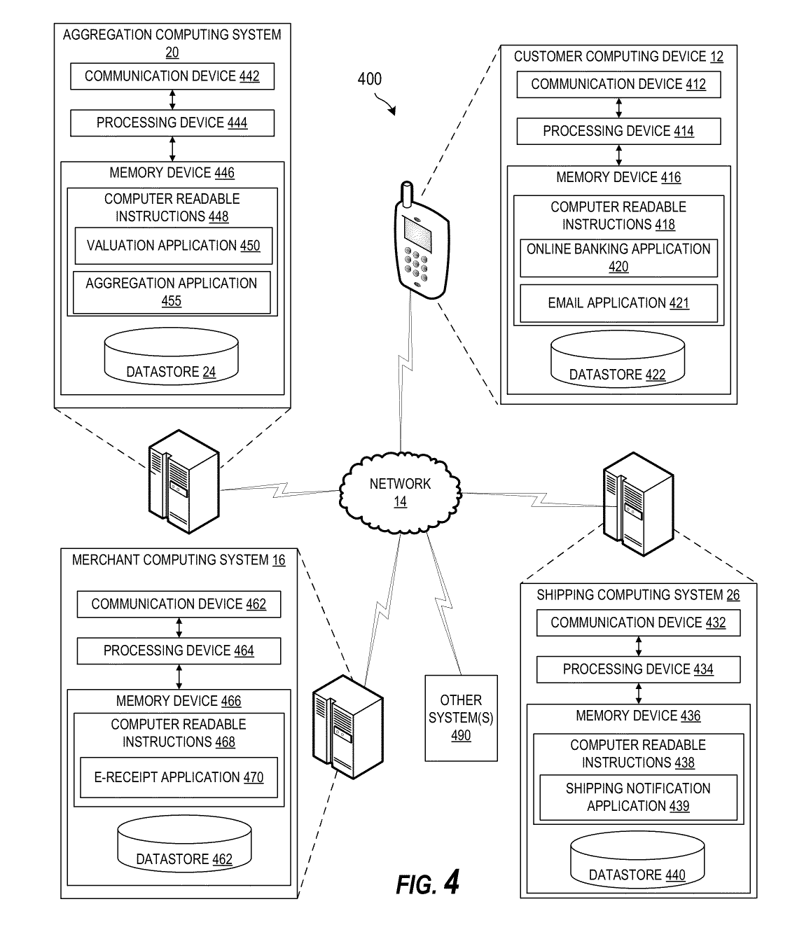

Referring now to the Figures, FIG. 1 illustrates a flowchart that provides an overview of a process 100 for providing e-receipt data, analyzing e-receipt data, and determining insurance valuations. One or more devices, such as the one or more devices and/or one or more other computing devices and/or servers of FIGS. 3-4, can be configured to perform one or more steps of the process 100 or 200 described below. In some embodiments, the one or more devices performing the steps of the processes are associated with a financial institution. In other embodiments, the one or more devices performing the steps of the processes are associated with a merchant, business, partner, third party, credit agency, account holder, and/or user.

As illustrated at block 102, e-receipt data is received from a customer and/or merchant. For example, the customer may instruct the merchant to send at least a portion of the e-receipt data to the system of process 100. In other embodiments, the e-receipt data is received from a third party. The e-receipt data includes data associated (e.g., extracted) from a proof of purchase document, online confirmation communications, online customer accounts, shipping notices, order confirmation, and the like. The customer may, for example convert a paper receipt to an electronic document, forward an email containing a shipping notification, provide a purchase confirmation page from their online account, and the like. Retrieving e-receipt data is discussed in more detail below with regard to FIG. 3.

The e-receipt data includes detailed information regarding the products or services purchased. For example, in the case of a product, the order confirmation may include stock keeping unit “SKU” code level data. As used herein, “SKU level data” includes but is not limited to data associated with an identifier, code, or other data that embodies attributes associated with an item such as a good or service. These attributes include, but are not limited to, manufacturer, product description, material, size, color, packaging, quantity, warranty terms, and the like. As described hereinabove, the e-receipt data can includes other parameters such as order number, order date, product name, product price, product image, hyperlink to the product image on merchant website, sales tax, shipping cost, order total, billing address, shipping company, shipping address, estimated shipping date, estimated delivery date, tracking number, and the like.

As illustrated at block 104, the e-receipt data is restructured. An initial barrier to integration of electronic communication data received by a customer from a merchant regarding a purchase transaction for inclusion into online banking is data format is incompatibility or differences in data structures between e-receipt data and other data such as transaction data. Online banking data, for example, is in a structured form. Financial institutions use a data structure conforming to Open Financial Exchange “OFX” specifications for the electronic exchange of financial data between financial institutions, businesses and customers via the Internet. E-receipts, such as electronic order confirmations, shipment confirmation, receipts, and the like typically do not comply with a uniform structure and are generally considered to include data in an “unstructured” format. For example, while one merchant may provide data in an electronic communication to a customer in one format, another merchant may use a completely different format. One merchant may include merchant data at the top of a receipt and another merchant may include such data at the bottom of a receipt. One merchant may list the purchase price for an item on the same line as the description of the item and list the SKU number on the next line, while another merchant may list the data in a completely opposite order. As such, prior to integration of electronic communications relating to customer purchases into online banking, the data from such electronic communications must be parsed into a structured form, which is described in more detail below with regard to FIG. 3.

As illustrated at block 106, the e-receipt data and the transaction data is compared. In cases where the e-receipt data is restructured for data compatibility, the restructured e-receipt data is compared to the transaction data. The transaction data includes transaction amounts, transaction dates, accounts used for the transaction, account balances before and after the transaction, account numbers, account types, account holder data, merchant data, and the like. Exemplary transactions include, for example, purchases, rebates, automatic bill pay, withdrawals, deposits, transfers, ATM related transactions, debit or credit card transactions, and the like.

In some embodiments, the e-receipt data and/or the transaction data is categorized. Each of the transaction data and the e-receipt data can be categorized by date, merchant, transaction amount, transaction channels, accounts, customers, and the like. By breaking down the transaction data and/or e-receipt data into segments, smaller chunks of data can be identified and cross-referenced.

As illustrated at block 108, the e-receipt data is matched to a transaction based on the comparison. In some embodiments, and as described herein, the transaction includes one or more transactions. Any number of parameters can be used to match the e-receipt data to the transaction data. For example, the e-receipt data and the transaction data may be matched based on date, merchant identity, transaction location, and/or transaction amount. The system of process 100 may base the matching on a sequence of matches. For example, if the transaction data indicated that only one transaction occurred on a certain day, the system 100 may easily match the single transaction to a purchase occurring on the same day in the e-receipt data. If date or time information is missing or cannot be used to match a specific piece of transaction data to a specific piece of e-receipt data, then other data can be layered into the comparison. If the transaction data indicates that a purchase was made at 9:42 AM EST on January 3^{rd}, but not such data can be found in the e-receipt data, the system can ask the customer or merchant for input, determine if there was delay in the processing of the purchase, identify an error in the transaction data and/or e-receipt data, review the customer's transaction history, and the like. In still other cases, a customer may make several purchases via a single merchant on the same day using the same credit card for the same purchase amount. For example, it may be beneficial for a customer to buy the same or similar item in separate orders to obtain a discount. In such cases, the system may look to the shipping destinations in the e-receipt data, the product codes, or other e-receipt data to determine matches between the e-receipt data and the similar purchases.

As illustrated at block 110, at least one insurance related transaction is identified from the one or more transactions. The at least one insurance related transaction includes purchases, automatic payments, withdrawals, and deposits that are related to one or more insurance policies or that have the potential to be related to an insurance policy.

In some embodiments, the at least one insurance related transaction is identified based on the product description, the merchant, the transaction amount, the transaction data, or other transaction and e-receipt data. For example, if a purchase item relates to home repair (e.g., shingles) and if the purchase is associated with a home improvement store, a home insurance related transaction can be identified. In still other examples, the total number of purchases during a period of time or the amount of each purchase must be above a certain amount in order to be identified as an insurance related transaction. For example, if the customer has only bought $5 worth of building materials to repair a lighting fixture in their home, such purchases may not be worthwhile to tag for insurance purchases. If the total amount of purchases for the entire years is above $500 or if a single purchase is over $100, then such purchases may be tagged as insurance related transactions.

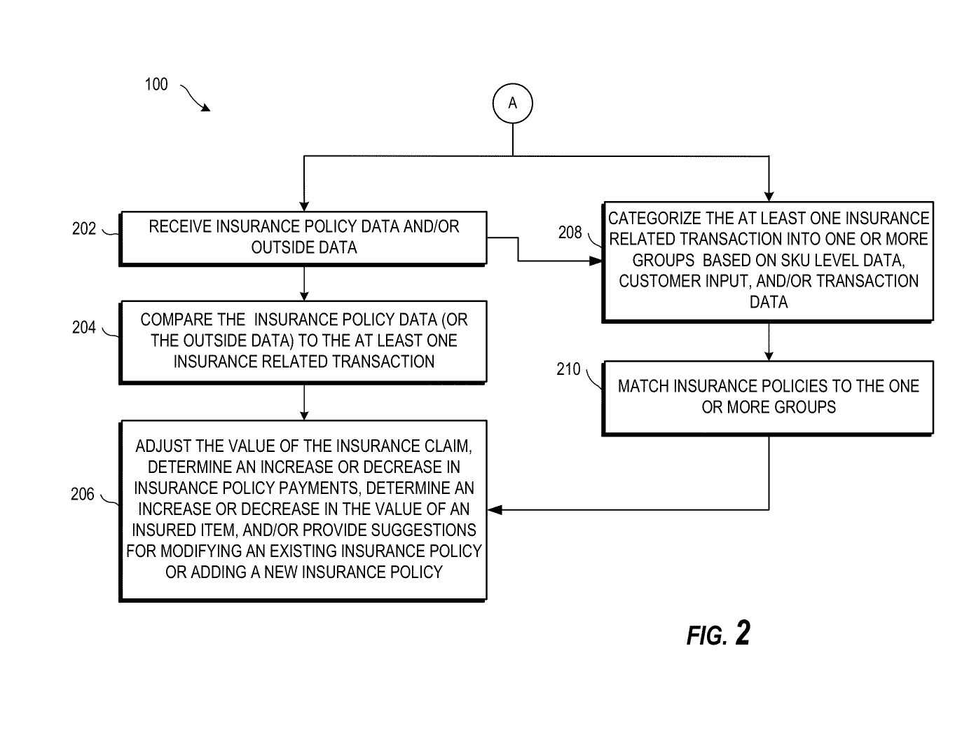

In some embodiments, the insurance related transaction is identified based on insurance data received from the customer (see, e.g., FIG. 2). If a customer has renter's insurance, for example, the system of process 100 may quantify the number of purchases and the amount of purchases that are stored in the customer's apartment. If the customer buys a laptop for their own personal use at home, the system may identify such a purchase as related to the customer's renter's insurance policy. The customer, in some cases, may provide the at least one insurance related transaction to an insurance company to determine the terms of their policy.

As illustrated at block 112, an insurance transaction is processed based on the at least one insurance related transaction. For example, the system of process 100 may provide a listing of the at least one insurance related transaction to the customer, value an insurance claims, submit a proof of purchase for an insurance claims to the customer's insurance company, and the like. In some embodiments, the insurance claim is based on at least a portion of the purchase amount of the at least one insurance related transaction. For example, a contractor's quote for repairing a wall damaged by flood waters may be used to originally value an insurance claim for property damage. Additional insurance related transaction can also be included in valuing the insurance claims such as hotel expenses, storage expenses, or building materials. The system enables a customer to reassess their insurance claims by providing additional details to the customer. In other embodiments, the terms of one or more insurance policies are used to value the insurance claim as described in more detail below.

Referring now to FIG. 2, the process 100 is further illustrated. As illustrated at block 202, insurance policy data and/or outside data is received. In some embodiments, the insurance data and/or outside data is received from the customer, an insurance company, government agency, or other third party. The insurance policy data includes terms of one or more insurance policies including start and expiration dates of coverage, account numbers, insured item values, insured item descriptions, rider clauses, types of coverage, coverage parameters, and the like. Outside data includes government records, industry publications, economic surveys, statistics, studies, real estate reports, social media data, and any other publically available or received data. For example, the system of process 100 can extract real estate property values, car theft rates, fire hydrant locations, and so forth to aid in processing the insurance transactions, identifying the at least one insurance transaction, and the like. In some embodiments, the outside data is related to the insurance policy data. For example, the system may search and extract data from news sources or other publically available sources based on the types of insurance used by the customers. In other cases, outside data is identified based on the at least one insurance related transaction. For example, if the customer recently purchased an engagement ring, the system may pull up outside data such as ring insurance plan reviews, rates of jewelry theft in the customer's neighborhood, and so forth.

As illustrated at block 204, at least a portion of the insurance policy data and/or the outside data is compared to the at least one insurance related transaction. Any number of insurance policy parameters or outside data criteria can be used to make the comparison. Coverage start and end dates can be compared to purchase dates of the at least one transaction. The product description of the at least one insurance related transaction can be compared to the terms of the insurance policy. The comparison of the insurance policy data and/or the outside data can be used to adjust calculations, provide suggestions, and evaluate data as described below.

As illustrated at block 206, the value of the insurance claim is adjusted. In some embodiments, an increase or decrease to the value of the insurance claim is calculated, or a change to the terms of the insurance claim is provided. Outside data such as changes in law, changes in real estate values, new construction, increases or decreases in the price of gold, and the like can be used to adjust the value of a home insurance claim, a ring insurance claim, and the like. In other cases, the terms of the policy may require additional or different data such as an explanation of services received, photos of damage, a different format for the insurance claim, additional forms, and the like. The system of process 100 can prompt the customer to provide this additional data to the insurance company or provide the section of the insurance policy dealing with the additional data to the customer. In still other examples, a second insurance claim is identified based on the comparison. If two or more insurance policies overlap in coverage, the customer may be entitled to two different reimbursements. Further, in some instances one or more insurance policies may lapse, which may require a recalculation of the value of the insurance claim, renewal of the lapsed policy, or cancellation of the insurance claim.

In some embodiments, a second valuation of the insurance claim is received. For example, the outside data or the insurance policy data may comprise an estimate of repairs and the amount that can be covered under the customer's policy from a third party or the insurance company. The system of process 100 can compare the second valuation of the insurance claim and the calculated value of the insurance claim to determine any variances between the valuations and the reasons for such variances. For example, the original value of the insurance claim may be based on outdated data, incorrect data, or faulty calculations, or vice versa. The system may compare the dates of the two calculations to determine which is the most current. In some embodiments, the calculated value of the insurance claims is adjusted (i.e., increased or decreased) based on the reason for the variance. For example, if the reason for the variance between the two valuations is due to incomplete data, the calculated value may be adjusted in accordance with the additional data.

In further embodiments, an increase or decrease in insurance policy payments is determined based on the comparison of the insurance policy data and/or outside data with the at least one insurance related transaction. The system of process 100 give the customer tools for negotiating contract terms and payments. For example, modifications that enhance the security of the insured item; deductible increases or decreases; a customer move to a new geographic area; changes in law; and the like can be used to determine an increase or decrease in monthly or yearly payments for an insurance policy. If a homeowner updates old windows to more secure and energy efficient windows or if local government installs a fire hydrant within close proximity of the homeowner's house, the monthly payment for an insurance policy or rider policy may decrease. In other cases, payments may automatically increase (e.g., if the insured item is a condo in a growing area) or decrease (e.g., if the insured item is a car) over the life of the insured item as the value of the insured item goes up or down.

In other embodiments, an increase or decrease in the value of an insured item is determined. As noted above, some insured items such as an automobile may automatically decrease in value the longer the customer owns the car, while other insured items such as jewelry and real property may fluctuate according to market trends, upgrades to the insured item, damage to the insured item, and the like. In cases where the at least one insurance related transaction affects the value of the insured item (such as an addition to a house), the system can calculate how much the at least one insurance related transaction has affected the value of the insured item. For example, the system of process 100 may identify the closing price of similar homes in the customer's neighborhood that have similar upgrades to adjust the value of the customer's insured house.

In additional embodiments, suggestions for modifying an existing insurance policy or adding a new insurance policy is provided to the customer. For example, a customer that forms a new business may be unaware that the current coverage or existing insurance policy is inadequate for covering business losses or property damage. In such cases, suggestions for purchasing new insurance policy plans, negotiating new rider policies, expanding or detracting coverage, combining one or more insurance policies, and the like may be provided to the user. The suggestions can be provided on the customer's online banking account, via email, text, paper mail, fax, voice, video, and the like. The customer may be provided with an informational pop-up video on insurance claims, for example, when they review their monthly statements. The suggestions also include, for example, instructions on how to submit or modify an insurance claim for their particular insurance policy, guidance on choosing a new insurance policy, and the like.

In further embodiments, one or more of the at least insurance related transaction is re-categorized or otherwise dissociated with an insurance policy based on customer input, the outside data, and/or the insurance policy data. For example, if a customer submits a new address, buys a new car, or submits a deposit, the system of process 100 may determine that previously identified insurance related transactions are no longer related to an insurance policy. If the customer moves from a rented apartment to a home that they have just purchased, the system may remove tags for transactions related to renter's insurance and/or retag those transaction as now being related to home owner's insurance. An incoming deposit comprising an image of a check that indicates the customer's boat has been sold (e.g., memo line indication or amount of the check) may be used to determine that boat related purchases are no longer associated with an insurance policy and that any future boat product purchases are not to be identified as insurance related until the customer indicates otherwise. In other examples, the customer may simply submit data indicating that they have sold an insured item or have otherwise disposed of the insured item, or cancelled an insurance policy.

As illustrated at block 208, that at least one insurance related transaction is categorized into one or more groups based on SKU level data, customer input, and/or transaction data. The SKU level data can be used to identify types of purchases according to product descriptions such that all healthcare related items, for example, may be categorized into a single category (e.g., health) or sub-categories (e.g., prescriptions, over the counter, dental, and the like). In some embodiments, a single transaction of the at least one insurance related transaction overlaps with multiple types of groups. For example, a smart phone may be covered under a phone insurance plan, a manufacturer's warranty, and a renter's insurance plan and may thus be placed in both a phone group and a housing group. In other examples, a portion of a single transaction of the at least one insurance related transaction may be categorized into the one or more groups. For example, only home repair items from a big box store transaction may be included in a home group while other unrelated items purchased in the same transaction, such as clothing and car services, may be disregarded.

As illustrated at block 210, one or more insurance policies are matched to the one or more groups. For example, a health insurance policy and a supplemental prescription insurance plan may be matched to a health group. The health insurance policy may be further matched to various subgroups within the health group such as gym subgroup, a chiropractor subgroup, a vision subgroup, and a prescription subgroup, while the supplemental prescription insurance plan may only be matched to the prescription subgroup. In other cases, a single insurance policy may be matched to multiple groups. For example, a home owner's insurance policy with multiple rider polices may be matched to a home repair group, an automobile group, and a lawn service group. As insurance policy coverage expires or begins, or as insurance policy terms are upgraded, downgraded, or otherwise modified, the system of process 100 may modify the one or more groups or the matching between the one or more insurance policies and the one or more groups.

FIG. 3 is a diagram of an operating environment 10 according to one embodiment of the present invention for retrieval of electronic communications relating to customer purchase transactions, parsing of data within such electronic communications into structured data, inclusion of such data into online banking, and determining insurance values. As illustrated a consumer maintains one or more computing devices 12, such as a PC, laptop, mobile phone, tablet, television, or the like that is network enabled for communicating across a network 14, such as the Internet, wide area network, local area network, Bluetooth network, near field network, or any other form of contact or contactless network. Also, in the operating environment, are one or more merchant computing systems 16 that are network enabled. In the context of an online shopping experience, the merchant computing system 16 may be one or more financial transaction servers that, either individually or working in concert, are capable of providing web pages to a customer via the network 14, receiving purchase orders for items selected by the customer, communicating with the customer and third party financial institutions to secure payment for the order, and transmitting order confirmation, and possibly shipping confirmation information, to the customer via the network 14 regarding the purchase transaction. In the context of an in-store purchase, the merchant computing system 16 may include a point of sale terminal for scanning or receiving information about products or services being purchased by the customer and communicating with the customer and third party financial institutions to secure payment for the order. Either the point of sale device or a connected merchant server may be used to communicate order confirmation or purchase confirmation information to the customer related to the purchase transaction. If the customer has an online account with the merchant, the merchant computing system may also log the transaction information into the customer's online account.

In general, the merchant computing system will provide the customer with information relating to the purchase transaction. In the context of an online purchase, the communications may take the form of purchase order confirmations provided as a web page or as an email or as both. In some, embodiments, the merchant computing system may provide a web page purchase order confirmation, and advise the customer to either print, electronically save, or book mark the confirmation web page. The purchase order confirmation is essentially an e-receipt for the online purchase transaction. The order confirmation includes detailed information regarding the products or services purchased, such as for example, in the case of a product, SKU code level data including parameters associated with the product such as type/category, size, color, and the like, as well purchase price information, information associated with the merchant, and the like. The merchant computing system may also send other subsequent communications such as communications confirming shipment of the order, which typically includes the same information as the purchase order confirmation, and in addition, shipping date, tracking number, and other relevant information regarding the order. In the context of an in-store purchase, the merchant computing system may send an electronic receipt comprising information similar to that of the purchase order confirmation. In some instances, the customer may actually receive a paper receipt, which the customer may choose to scan into an electronic form and save in a storage device associated with the customer computing device 12. In the description herein, the term e-receipt may be used generically to refer to any communication or document provided by a merchant to a customer relating to a purchase transaction.

For a plurality of different purchase transactions, a customer may include purchase transaction related data (e.g., order confirmations, shipping confirmations, e-receipts, scanned receipts, typed or handwritten notes, invoices, bills of sale, and the like) in various locations and in various forms. The purchase related data could be stored in a storage device associated with the customer computing device 12, or in an email server 18, or in a customer's account at the merchant's computing system 16. Furthermore, as mentioned, the purchase transaction related information is in an unstructured format. Each merchant may use a customized reporting format for the communications, whereby various data relating to the purchase transaction may be placed in different sequences, different locations, different formats, etc. for a given merchant. Indeed, a given merchant may even use different data formatting and structuring for different communications with the customer (e.g., order confirmation, shipping, confirmation, e-receipt, online customer account information, and the like).

To aggregate and structure data related to purchase transactions, and in some cases, determine insurance values, the operating environment further comprises an aggregation computing system 20. The aggregation computing system 20 is operatively connected to at least one of the customer computing device 12, the merchant computing system 16, the authentication/authorization computing system 22, and/or the email server 18 via the network 14. The aggregation computing system 20 is configured to initially search and locate electronic communications associated with purchase transactions made by the customer, in for example, the customer's email, computer storage device, online accounts, and the like. For this purpose, the system may optionally include an authentication/authorization computing system 22 that comprises security IDs and passwords and other security information associated with the customer for accessing customer's email, storage devices, and customer online accounts.

Regarding email extraction, aggregation computing system 20 initially gains access to the customer's email accounts and retrieves email message headers comprising data fields relative to the email message, such as sender, subject, date/time sent, recipient, and the like. In some embodiments, the aggregation computing system accesses the emails directly. In other embodiments, the aggregation computing system may run search queries of the email database based on known merchant names and/or phrases associated with e-receipt information, such as “receipt,” “order confirmation,” “shipping confirmation,” or the like. Once emails are extracted, further filtering may occur to locate relevant emails. Examples of further filtering may be searches based on known online merchants, third parties known to provide e-receipts, text in the email message subject line that corresponds to known order confirmation subject line text or known shipping confirmation subject line text, such as an email message sent with a subject line containing the text “purchase,” “order,” “ordered,” “shipment,” “shipping,” “shipped,” “invoice,” “confirmed,” “confirmation,” “notification,” “receipt,” “e-receipt,” “ereceipt,” “return,” “pre-order,” “pre-ordered,” “tracking,” “on its way,” “received,” “fulfilled,” “package,” and the like.

Based on the email header analysis, the message bodies for emails of interest may then be accessed. The retrieved email message bodies for the identified email messages of interest are parsed to extract the purchase transaction information and/or shipping information contained therein. Such parsing operation can occur in a variety of known ways. However, because the text contained in email message bodies is un structured (as opposed to the structured tagged elements in a hypertext markup language (HTML) web page which delineate and make recognizable the various fields or elements of the web page), in one embodiment predefined templates are used that have been specifically created to identify the various individual elements or entities of interest in a given email from an online merchant. Use of these predefined templates to parse a retrieved email message body occurs within aggregation computing system 20. Because it is known from header information which merchant sent the email message of interest and whether the email message is a purchase order confirmation or a shipping confirmation from either the header or the message body information, a template specific to the merchant and type of confirmation may be used. Still further, because email message bodies can, as is known in the art, be in either a text or HTML format, a template specific to the type of email message body format may be used in some embodiments.

As an example, for each merchant there are typically four different parsing templates which can be used for electronic communications relating to purchase transactions: i) a text order confirmation template; ii) an HTML order confirmation template; iii) a text shipping confirmation template; and iv) an HTML shipping confirmation template. Where the email is an e-receipt from a brick and mortar purchase, another template may be used that is specific to the merchant. For some online merchants there are greater or fewer templates depending upon what are the various forms of email messages a given online merchant typically sends. Regardless of the number of templates for a given merchant, each template is specific as to the known particular entities typically included and the order they typically occur within each type of email confirmation message sent by that merchant.

The above describes parsing of email purchase order confirmation, shipping confirmation, typed or handwritten notes, invoices, bills of sale, or other e-receipt data. As mentioned, a customer may scan and save paper receipts in a storage device or print and save purchase order and shipping confirmation communications sent to the customer by the merchant via a web page. In this instance, the aggregation computing system 20 may first perform optical character recognition “OCR” on the scanned or printed receipts prior to performing the processing performed above. Further, a customer may maintain an online account with a merchant containing purchase data information. In this instance, the aggregation computing system 20 will access the data online via communication with merchant computing system 16 to retrieve this data. The aggregation computing system 20 may use column and/or row headers associated with the online data to parse the data, or it may use procedures similar to the above and discussed below to parse the data into appropriate fields.

Returning to data processing procedures, in some embodiments, context-free grammars “CFGs” are used to parse fields from purchase transaction data. In some embodiments, instead of using grammars for parsing natural language (e.g., English) structures, the system may use defined smaller grammars describing a particular message format, for example: “(Greetings from merchant)(Details about order)(Details about item 1)(Details about item 2) . . . (Details about item N)(Tax and totals calculation),” and the like. Further, the CFGs may be individually defined, such as in a Backus-Naur Form (BNF) format, or templates may be used for data extraction. In instances, where templates are used, these created templates are grammar and can be converted by known tools, such as Another Tool for Language Recognition “ANTLR”, into mail-specific grammars or e-receipt-specific grammars or online customer account information-specific grammars. ANTLR is then used again to convert these grammars into extraction parsers, which can be used by the aggregation computing system 20 to parse the email message bodies, e-receipt bodies, online data, etc. to extract the entities of interest from them. Examples of such extracted entities include merchant name, merchant web address, order number, order date, product description, product name, product quantity, product price, product image, hyperlink to the product image on merchant website, sales tax, shipping cost, order total, billing address, shipping company, shipping address, estimated shipping date, estimated delivery date, tracking number, and the like.

Other extraction parsers may be used, such as regular expression extraction, which can be used as a brute force pattern matching approach across the purchase information record. With this technique, each word in a given purchase order record is matched against a set of rules. If the rules are met, the piece of text matching the set of rules is returned. For example, shipping companies frequently use a 21 digit tracking number beginning with “1Z” or “91.” The aggregation computing system may scan an entire purchase information record to find a 21 digit number with “1Z” or “91” as the first 2 digits. The matched text can then be extracted and used to determine shipping information.

In another embodiment, an HTML document object model (DOM) approach may be used to parse purchase data records. For example, the message body of an email shipping notification may contain HTML code with tags for order, shipping and/or tracking information. The aggregation computing system may use these tags to identify the shipping and/or tracking information for extraction.

Once relevant information is extracted from communications between the customer and merchant regarding purchase transactions, it is stored in purchase data records in a structured database 24.

As is understood, once the purchase transaction data has been extracted, various information regarding a particular purchase transaction is now known, such as merchant name, merchant web address, order number, order date, product description, product name, product quantity, product price, product image, hyperlink to the product image on merchant website, sales tax, shipping cost, order total, billing address, shipping company, shipping address, estimated shipping date, estimated delivery date, tracking number, and the like. This data can be further enriched with additional and/or updated information associated with products or services within the data. For example, the data may be enriched with updated shipping and delivery information from a shipping company computer system 26, product images, information about product returns, warranty information, recall information, and the like. In particular, the aggregation computing system may (1) communicate with the merchant and/or shipping company to update the shipping and delivery information extracted and stored in the database, (2) may search the merchant or the web in general to retrieve product images, and/or (3) communicate with merchant for return policies, warranties, insurance, recalls, and the like.

The above is a description of an aggregation computing system according to one embodiment of the present invention. An example of an aggregation computing system is described in U.S. Published Patent Application No. 2013/0024525 titled Augmented Aggregation of Emailed Product Order and Shipping Information, the contents of which are incorporated herein by reference.

Referring now to FIG. 4, a block diagram illustrates an environment 400 for determining insurance valuations. The environment 400 includes the customer computing device 12, the aggregation computing system 20, the shipping computing system 26, and the merchant computing system 16 of FIG. 3. The environment 400 further includes one or more other systems 490 (e.g., insurance company systems, the authentication/authorization system 22, the email server 18, a partner, agent, contractor, other user, third party systems, external systems, internal systems, and so forth). The systems and devices communicate with one another over the network 14 and perform one or more of the various steps and/or methods according to embodiments of the disclosure discussed herein.

The customer computing device 12, the aggregation computing system 20, the shipping computing system 26, and the merchant computing system 16 each includes a computer system, server, multiple computer systems and/or servers or the like. The aggregation computing system 20, in the embodiments shown has a communication device 442 communicably coupled with a processing device 444, which is also communicably coupled with a memory device 446. The processing device 444 is configured to control the communication device 442 such that the aggregation computing system 20 communicates across the network 14 with one or more other systems. The processing device 444 is also configured to access the memory device 446 in order to read the computer readable instructions 448, which in some embodiments includes a valuation application 450 for determining insurance valuations and an aggregation data application 455. The memory device 446 also includes a datastore 24 or database for storing pieces of data that can be accessed by the processing device 444. In some embodiments, the datastore 24 includes online session data such as transaction data, user input, and device tracking data, as well as login data, device registration data, user data, and the like.

As used herein, a “memory device” generally refers to a device or combination of devices that store one or more forms of computer-readable media and/or computer-executable program code/instructions. Computer-readable media is defined in greater detail below. For example, in one embodiment, the memory device 446 includes any computer memory that provides an actual or virtual space to temporarily or permanently store data and/or commands provided to the processing device 444 when it carries out its functions described herein.

The customer computing device 12 includes a communication device 412 communicably coupled with a processing device 414, which is also communicably coupled with a memory device 416. The processing device 414 is configured to control the communication device 412 such that the customer computing device 12 communicates across the network 14 with one or more other systems. The processing device 414 is also configured to access the memory device 416 in order to read the computer readable instructions 418, which in some embodiments includes an online banking application 420 and an email application 421. The memory device 416 also includes a datastore 422 or database for storing pieces of data that can be accessed by the processing device 414.

The shipping computing system 26 includes a communication device 432 communicably coupled with a processing device 434, which is also communicably coupled with a memory device 436. The processing device 434 is configured to control the communication device 432 such that the shipping computing device 322 communicates across the network 14 with one or more other systems. The processing device 434 is also configured to access the memory device 436 in order to read the computer readable instructions 438, which in some embodiments includes a shipping notification application 439. The memory device 436 also includes a datastore 440 or database for storing pieces of data that can be accessed by the processing device 434.

The merchant computing system 16 includes a communication device 462 communicably coupled with a processing device 464, which is also communicably coupled with a memory device 466. The processing device 464 is configured to control the communication device 462 such that the shipping computing device 322 communicates across the network 14 with one or more other systems. The processing device 464 is also configured to access the memory device 466 in order to read the computer readable instructions 468, which in some embodiments includes an e-receipt application 470. The memory device 466 also includes a datastore 462 or database for storing pieces of data that can be accessed by the processing device 464.

In some embodiments, the online banking application 420, the shipping notification application 439, and/or the e-receipt application 470 interact with the valuation application 450 and/or aggregation application 455 to aggregate electronic data and determine insurance valuations for the customer associated with the device 12 as described herein.

The applications 420, 439, 450, 455, and 470 are used for instructing the processing devices 414, 434, 444 and 464 to perform various steps of the methods discussed herein, and/or other steps and/or similar steps. In various embodiments, one or more of the applications 420, 439, 450, 455, and 470 are included in the computer readable instructions stored in a memory device of one or more systems or devices other than the systems 18, 20, 16, 26, and 490 and the device 12. For example, in some embodiments, the application 420 is stored and configured for being accessed by a processing device of one or more third party systems (e.g., the other systems 490) connected to the network 14. In various embodiments, the applications 420, 439, 450, 455, and 470 are stored and executed by different systems/devices are different. In some embodiments, the applications 420, 439, 450, 455, and 470 are stored and executed by different systems may be similar and may be configured to communicate with one another, and in some embodiments, the applications 420, 439, 450, 455, and 470 may be considered to be working together as a singular application despite being stored and executed on different systems.

In various embodiments, one of the systems discussed above, such as the aggregation computing system 20, is more than one system and the various components of the system are not collocated, and in various embodiments, there are multiple components performing the functions indicated herein as a single device. For example, in one embodiment, multiple processing devices perform the functions of the processing device 444 of the aggregation computing system 20 described herein. In various embodiments, the aggregation computing system 20 includes one or more of the external systems and/or any other system or component used in conjunction with or to perform any of the method steps discussed herein. For example, the aggregation computing system 20 may include a aggregation computing system, a credit agency system, and the like.

In various embodiments, the aggregation computing system 20, the shipping computing system 26, the merchant system 16, the customer computing device 12, the other system 490, and/or other systems may perform all or part of a one or more method steps discussed above and/or other method steps in association with the method steps discussed above. Furthermore, some or all the systems/devices discussed here, in association with other systems or without association with other systems, in association with steps being performed manually or without steps being performed manually, may perform one or more of the steps of method 100, the other methods discussed above, or other methods, processes or steps discussed herein or not discussed herein.

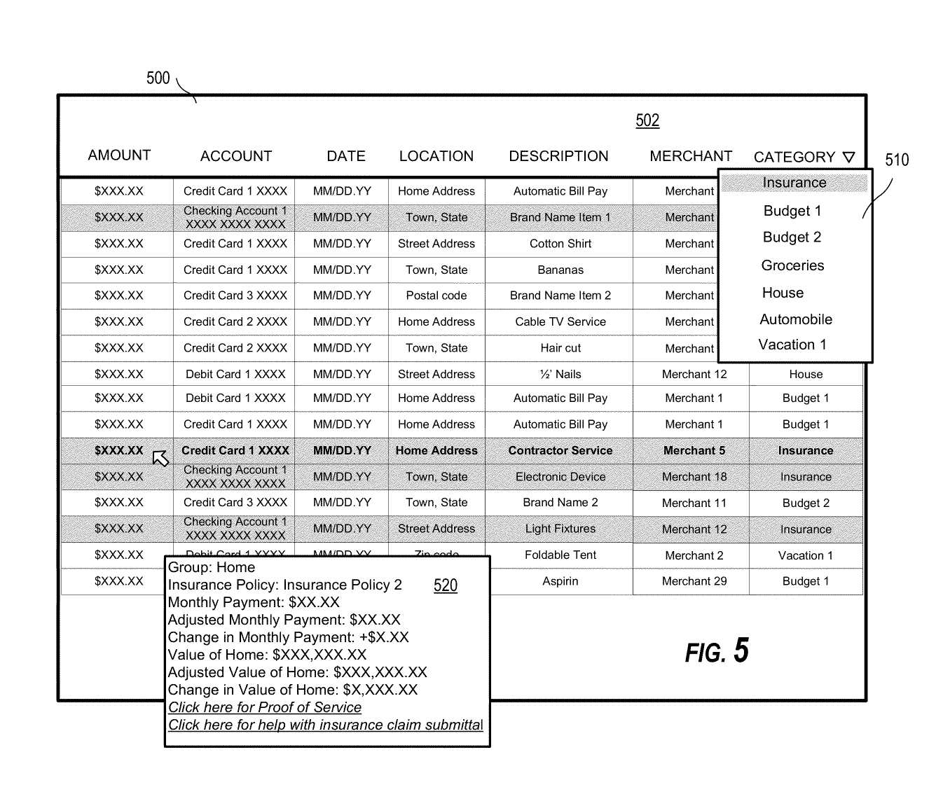

Referring now to FIG. 5, an exemplary graphical user interface (GUI) 500 of a computing device (e.g., the customer computing device 12 in FIG. 3) is illustrated. In FIG. 5, an exemplary transaction listing 502 is provided. In some embodiments, a customer accesses an online banking account to retrieve the transaction listing 502. The transaction listing 502 may be a monthly banking statement or a report associated with transactions that occur during a certain period of time. In the illustrated embodiment, the transactions in the transaction listing 502 are segmented into various portions that include, for each transaction, the transaction amount, the account used in the transaction, the transaction date, the transaction location, a description of the transaction, a merchant associated with the transaction, and a category of the transaction. It will be understood that any number of portions can be included in the transaction listing 502 to better define the transaction or otherwise enhance the customer's online experience. Under the Account column, the identity and type of account (debit card, credit card, and checking account) are provided, as well as at least a portion of the account number for each account. The Location column includes locations associated with each transaction s. In the Merchant column, one or more merchants associated with each transaction are provided.

In the illustrated embodiment, the “insurance” category is selected such that all Insurance related transactions are highlighted in the transaction list 502. In other embodiments, the transactions categorized as insurance are shown while all other are excluded. Further, in cases where the insurance categories overlap with one or more categories, by selecting the insurance category, the overlapping categories are shown as only insurance categories. In other embodiments, the insurance and another category (e.g., House) may be shown together (e.g., the transaction may be labeled House/Insurance). Further still, the rows with the overlapping categories may be color coded.

As shown in FIG. 5, a pop-up window is opened in response to a transaction being selected. The pop-window 520 includes information related to the selected transaction including the group associated with the insurance transaction (e.g, home), the type or name of the insurance policy, monthly payment for the policy, adjusted monthly payment calculation in light of the transaction, the difference in the amount between the previous monthly payment and the adjusted monthly payment, the adjusted value of the item being insured (i.e., the home), the difference in the amount between the previous value of the home (e.g., the value of the home listed in the insurance policy) and the adjusted value of the home in light of the contractor service. Further, the pop-window includes hyperlinks for providing a proof of the transaction (e.g., a PDF of an itemized transaction receipt for the contractor service, before and after photos, and the like) and a hyperlink for insurance claim submittal. The link can take the customer to the portions of relevant insurance policies that explain the procedure for submitting claims, the amount that the insurance policy will pay for the insurance claim (e.g., 80% of the contractor service, a maximum amount, an amount over the transaction amount, and so forth), and guidelines for determining if the insurance claim will be successfully processed. In other embodiments, the insurance claim hyperlink calculates the value of the insurance claim based on the selected transaction and in light of the terms of the relevant insurance policy, or prepares the form for submitting the insurance claims for the customer.

The flowcharts and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to embodiments of the disclosure in the form disclosed. Many modifications and variations will be apparent to those of ordinary skill in the art without departing from the scope and spirit of embodiments of the disclosure. The embodiment was chosen and described in order to best explain the principles of embodiments of the disclosure and the practical application, and to enable others of ordinary skill in the art to understand embodiments of the disclosure for various embodiments with various modifications as are suited to the particular use contemplated. Although specific embodiments have been illustrated and described herein, those of ordinary skill in the art appreciate that any arrangement which is calculated to achieve the same purpose may be substituted for the specific embodiments shown and that embodiments of the disclosure have other applications in other environments. This application is intended to cover any adaptations or variations of the present disclosure. The following claims are in no way intended to limit the scope of embodiments of the disclosure to the specific embodiments described herein.

What is claimed is:

1. A system for determining insurance valuations, the system comprising:
a computer apparatus including a processor and a memory; and
a valuation software module stored in the memory, comprising executable instructions that when executed by the processor cause the processor to:
receive e-receipt data comprising stock keeping unit (SKU) level data from a customer;
compare the e-receipt data with transaction data;
match the e-receipt data to one or more transactions based on the comparison;
identify at least one insurance related transaction from the one or more transactions based on the SKU level data; and
calculate the value of an insurance claim based on the at least one insurance related transaction.

2. The system of claim 1, wherein the executable instructions further cause the processor to:
receive insurance policy data from the customer;
compare the insurance policy data and the at least one insurance related transaction calculate the purchase amount for the at least one insurance related transaction.

3. The system of claim 2, wherein the executable instructions further cause the processor to:
adjust the purchase amount based on the insurance policy data,
wherein the value of the insurance claim comprises the adjusted purchase amount.

4. The system of claim 2, wherein the executable instructions further cause the processor to:
determine an increase or decrease in payments associated with an insurance policy of the customer based on the insurance policy data and the at least one insurance related transaction comparison.

5. The system of claim 2, wherein the executable instructions further cause the processor to:
determine that the value of an insured item has increased or decreased based on the insurance policy data and the at least one insurance related transaction comparison.

6. The system of claim 2, wherein the executable instructions further cause the processor to:
provide suggestions for modifying an existing insurance policy to the customer.

7. The system of claim 1, wherein the executable instructions further cause the processor to:
determine that the transaction data and the e-receipt data are dissimilar; and
restructure the e-receipt data.

8. The system of claim 1, wherein the executable instructions further cause the processor to:
receive outside data;
adjust the value of an insured item based on the outside data,
wherein the outside data comprises data extracted from government records, statistical reports, valuation models, or consumer reviews.

9. The system of claim 8, wherein the executable instructions further cause the processor to:
categorize the at least one insurance related transaction into one or more groups based on the SKU level data, customer input, or the transaction data.

10. The system of claim 1, wherein the executable instructions further cause the processor to:
receive insurance data comprising one or more insurance policies;
match the one or more insurance policies to the one or more groups.

11. The system of claim 1, wherein the executable instructions further cause the processor to:
receive a second value for the insurance claim;
determine variances between the calculated value of the insurance claim and the second value of the insurance claim; and
notify the customer of the variance.

12. A computer program product for determining insurance valuations, the computer program product comprising:
a non-transitory computer readable storage medium having computer readable program code embodied therewith, the computer readable program code comprising:
computer readable program code configured to receive e-receipt data comprising stock keeping unit (SKU) level data from a customer;
computer readable program code configured to compare the e-receipt data with transaction data;
computer readable program code configured to match the e-receipt data to one or more transactions based on the comparison;
computer readable program code configured to identify at least one insurance related transaction from the one or more transactions based on the SKU level data; and
computer readable program code configured to calculate the value of an insurance claim based on the at least one insurance related transaction.

13. The computer program product of claim 12, further comprising computer readable program code configured to receive insurance policy data from the customer and compare the insurance policy data and the at least one insurance related transaction calculate the purchase amount for the at least one insurance related transaction.

14. The computer program product of claim 13, further comprising computer readable program code configured to adjust the purchase amount based on the insurance policy data, wherein the value of the insurance claim comprises the adjusted purchase amount.

15. The computer program product of claim 13, further comprising computer readable program code configured to determine that the value of an insured item has increased or decreased based on the insurance policy data and the at least one insurance related transaction comparison.

16. The computer program product of claim 12, further comprising computer readable program code configured to determine that the transaction data and the e-receipt data are dissimilar and restructure the e-receipt data.

17. A computer-implemented method for determining insurance valuations, the method comprising:
receiving e-receipt data comprising stock keeping unit (SKU) level data from a customer;
comparing, by a processor, the e-receipt data with transaction data;
matching, by a processor, the e-receipt data to one or more transactions based on the comparison;
identifying, by a processor, at least one insurance related transaction from the one or more transactions based on the SKU level data; and
calculating, by a processor, the value of an insurance claim based on the at least one insurance related transaction.

18. The computer-implemented method of claim 17, further comprising:
receiving insurance policy data from the customer;
comparing, by a processor, the insurance policy data and the at least one insurance related transaction calculate the purchase amount for the at least one insurance related transaction.

19. The computer-implemented method of claim 18, further comprising:
adjusting, by a processor, the purchase amount based on the insurance policy data,
wherein the value of the insurance claim comprises the adjusted purchase amount.

20. The computer-implemented method of claim 18, further comprising:
determining, by a processor, an increase or decrease in payments associated with an insurance policy of the customer based on the insurance policy data and the at least one insurance related transaction comparison.
